(19) United States
(12) Patent Application Publication
(10) Pub. No.: US 2013/0092530 A1
(43) Pub. Date: Apr. 18, 2013

(54) APPARATUS FOR PRODUCING ELECTROLYTIC REDUCED WATER AND CONTROL METHOD THEREOF

(71) Applicant: Samsung Electronics Co., Ltd., Suwon-si (KR)

(72) Inventors: Chang Bae LIM, Suwon (KR); Tae Gyu KIM, Gwaseong (KR); Young Uk YUN, Suwon (KR); Young Chul KO, Suwon (KR)

(73) Assignee: Samsung Electronics Co., Ltd., Suwon-si (KR)

(21) Appl. No.: 13/648,705

(22) Filed: Oct. 10, 2012

(30) Foreign Application Priority Data
Oct. 14, 2011 (KR) 10-2011-0105515

(51) Int. Cl. C02F 9/00; C02F 1/469; C02F 1/04; C02F 1/44; C02F 1/461

(52) U.S. Cl. 204/252; 204/242; 210/243; 210/137

(57) ABSTRACT

An apparatus for producing electrolytic reduced water capable of electrolyzing purified water, which is filtered through reverse osmosis, by use of concentrated water that remains after the purification. The apparatus includes a water purifying apparatus, and an electrolytic cell provided with a first chamber having a cathode, a second chamber having an anode, and a third chamber disposed between the first chamber and the second chamber to receive concentrated water from the water purifying apparatus.

### CROSS-REFERENCE TO RELATED APPLICATIONS

This application claims the benefit of Korean Patent Application No. 10-2011-0105515, filed on Oct. 14, 2011 in the Korean Intellectual Property Office, the disclosure of which is incorporated herein by reference.

### BACKGROUND

1. Field

Embodiments of the present disclosure relate to an apparatus having an improved structure for producing electrolytic reduced water with a superior reducing power, and a control method thereof.

2. Description of the Related Art

As a water market has been developed along with economic growth, consumers have various selections in taking and drinking water. For example, drinking water can be acquired by taking water springs, boiling tap water, or purifying through a water purifier. Further, the consumers may install an alkaline ionized water creator at home to improve the health.

In the academic fields, all kinds of diseases and aging are accepted as being caused by activated oxygen. Such activated oxygen brings into a strong oxidation that deforms cells or genes of a human body, thereby causing various diseases. During the respiration and digestion where oxygen plays an important role, the activated oxygen continues to be created in the human body. In order to remove such activated oxygen, water having abundant activated hydrogen, that is, water having a reducing power is spotlighted.

Meanwhile, a Reverse Osmosis (RO) filter-type water purifier removes more than 70% to 90% of turbidity, germ, virus, organic compounds, agricultural chemicals, heavy metals, disinfected byproducts, and inorganic ion that exist in water, and creates pure water having a neutral pH 5.8 to pH 8.5 suitable as a drinking water. To this end, the water purifier is normally installed with three to five filters, and serves to keep the purified water in a storage water tank such that cold water and hot water are provided according to demands of a customer. As the water quality varies all over the world to a large degree, the RO filter-type water purifier has a great benefit to create water that is safe to drink regardless of the region in the world.

Despite such a superior purifying performance, the RO filter-type water purifier produces purified water from which even minerals are removed and which is hard to transfer an electric current, and thus has a difficulty in performing electrolysis.

Accordingly, there is a need for an electrolytic cell capable of producing reduced water having a high concentration of dissolved hydrogen by use of a reverse osmosis purification.

### SUMMARY

Therefore, it is an aspect of the present disclosure to provide an apparatus for producing electrolytic reduced water capable of electrolyzing pure water, which is filtered through reverse osmosis, by use of concentrated water that remains after the purification.

Additional aspects of the disclosure will be set forth in part in the description which follows and, in part, will be obvious from the description, or may be learned by practice of the disclosure.

In accordance with one aspect of the present disclosure, an apparatus for producing electrolytic reduced water includes a water purifying apparatus and an electrolytic cell. The electrolytic cell may be provided with a first chamber having a cathode, a second chamber having an anode, and a third chamber disposed between the first chamber and the second chamber to receive concentrated water from the water purifying apparatus.

The water purifying apparatus may include a reverse osmosis filter, a distillatory apparatus, and a capacitive deionization apparatus.

The apparatus may further include a valve configured to control a flow of purified water supplied from the water purifying apparatus such that the purifier water is supplied to the first chamber or the second chamber.

The electrolytic cell may include a cation exchanger membrane that is formed between the first chamber and the third chamber and between the third chamber and the second chamber.

The cathode may come into close contact with the cation exchange membrane, and the anode may come into close contact with the cation exchange membrane.

Each of the cathode and the anode is formed thereon with a pore that allows water to pass therethrough.

Each of the cathode and the anode is provided in a mesh-type structure.

The water purifying apparatus may supply the first chamber or the second chamber with the purified water, and may supply the third chamber with concentrated water that remains after generating the purified water.

The cathode and the anode may be reversed with each other to prevent scales from being formed on the cathode.

As described above, the present disclosure can produce reduced water having a high purity and high concentration of dissolved hydrogen by use of a reverse osmosis scheme.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a schematic view illustrating the concept of operation of an alkaline ionized water creator.

FIGS. 2A and 2B are schematic views illustrating the concept of operation of an apparatus for producing electrolytic reduced water according to an embodiment of the present disclosure.

FIGS. 3A and 3B are views illustrating the shape of an electrode used in the apparatus for producing electrolytic reduced water according to the embodiment of the present disclosure.

FIG. 4 is a view illustrating the configuration of a cation exchanger membrane and an electrode in an apparatus for producing electrolytic reduced water according to an embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

Hereinafter, the present disclosure will be described in detail with reference to the accompanied drawings.

An apparatus for producing electrolytic reduced water according to the embodiment of the present disclosure includes a water purifying apparatus and an electrolytic cell that is provided with a first chamber 26 having a cathode 23, a second chamber 27 having an anode 24, and a third chamber 28 disposed between the first chamber 26 and the second chamber 27 to receive a concentrated water from the water purifying apparatus.

The apparatus for producing electrolytic reduced water according to the embodiment of the present disclosure adopts benefits of a water purifier and an alkaline ionizer, in which the water purifier produces pure water which is deprived of heavy metals, organic substances, and inorganic ion but fails to have a reducing power while the alkaline ionizer produces alkaline water that only satisfies the basic level for purified water by removing only free chlorine residual, chromaticity, turbidity, and chloroform. Accordingly, the apparatus for producing electrolytic reduced water according to the embodiment of the present disclosure produces clean and safe water which does not have microorganism, germs, chlorine residual, heavy metals, organic compounds, and pesticide, and adds a high reducing power.

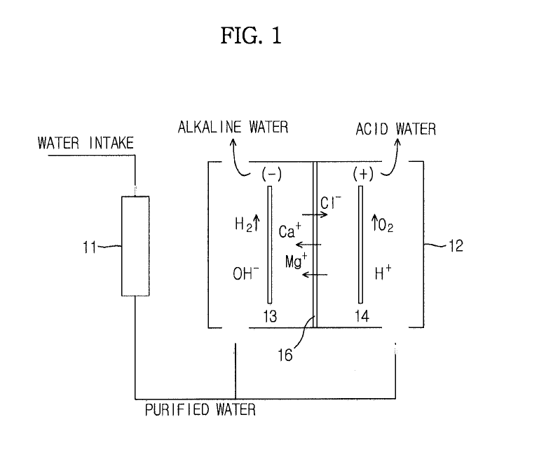

FIG. 1 is a schematic view illustrating the concept of operation of an alkaline ionized water creator.

An alkaline ionized water creator includes an ultra filtration (UF) filter 11 and an electrolytic decomposition cell (hereinafter referred to as an electrolytic cell) 12, and the electrolytic cell 12 includes a cathode 13, an anode 14, and an ion exchanger membrane 16 disposed between the cathode 13 and the anode 14.

Water, while being filtered through the UF filter, is deprived of microorganism having an invisible size of 0.01 μm or above, such as virus, corpuscle germ, and spores of algae, and pass small ions and microscopic elements having a size smaller than 0.01 μm. The water purified as such is input into the electrolytic cell 12 and a predetermined electric energy is applied to the electrolytic cell 12, thereby performing electrolysis. The electrolysis occurring at the cathode 13 and the anode 14 is represented as reaction 1 shown below.

Cathode (negative electrode): 2H₂0+2e⁻>H₂+2OH⁻, E⁰=−0.828V

Anode (positive electrode): 4H⁺+O₂+4e⁻>2H₂O, E⁰=+1.229V [Reaction 1]

When assumed that only OH⁻ and H² exist in water, the electromotive force of oxidation reduction potential (ORP) of the water created by the cathode 13 with respect to the standard hydrogen electrode is represented as equation 1 shown below.

$$E = 828 - ( \frac{59}{n} ) log ( \frac{{H}_{2 - standard}}{{H}_{2 - cathode} \times {( {OH}^{-} )}^{2}} ) \qquad [ Equation 1 ]$$

In equation 1, n represents the number of reactive electrons, H_{2-standard} represents the concentration of H₂ (mol/L) in a standard hydrogen electrode, H_{2-cathode} represents the concentration of H₂ (mol/L) in a cathode, and OH⁻ represents the concentration of OH⁻ (mol/L).

Since a spontaneous reaction occurs and electrons move from an indicator electrode to a standard hydrogen electrode until E=E⁺−E⁻ becomes from a positive value to OmV, the oxidation reduction potential is represented as a negative value, and the water dipped with the indicator electrode has a reducing power. If electrons move from the standard hydrogen electrode to the indicator electrode, the oxidation reduction potential is represented as a positive value, and the indicator solution has an oxidizing power.

If a positive voltage (E=E⁺−E⁻=1.229−(−0.828)=2.057V) as shown in reaction 1 is applied to the anode, the water at the cathode takes on alkali by hydrogen gas (H²) and hydroxyl (OH⁻) that are generated at the cathode, and the ORP is decreased to have a negative value according to equation 1. The water at the anode takes on acidity by oxygen gas (O₂) and hydrogen ions (H⁺) generated at the anode, and the ORP has a positive value according to equation 1.

In general, a Reverse Osmosis (RO) filter-type water purifier has a basic purifying function of removing free chlorine residual, chromaticity, turbidity, chloroform, microorganism, and germs, and further has a specific purifying function of removing organic compounds, agricultural chemicals, heavy metals, and inorganic ion, and thus produces a purified water having an average conductivity of 5˜15 μs/cm. In consideration that tap water has an average conductivity of 200˜220 μs/cm the purified water has a conductivity of 1/15˜1/40 of the conductivity of the tap water. Such purified water passing through the RO filter has a very low conductivity, causing a difficulty in electrolysis. That is, in acquiring the reduced water, the pure water filtered through the reverse osmosis is not easily electrolyzed using an electrolytic cell having two electrode chambers.

The apparatus for producing electrolytic reduced water according to the embodiment of the present disclosure can produce the electrolytic reduced water with a superior reducing power by electrolyzing the pure water passing through the RO filter.

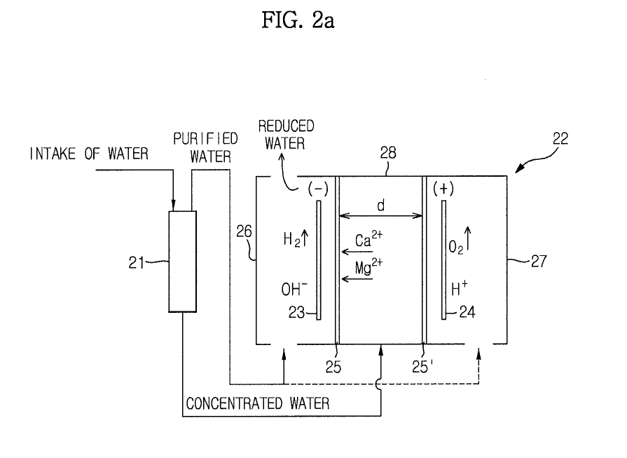

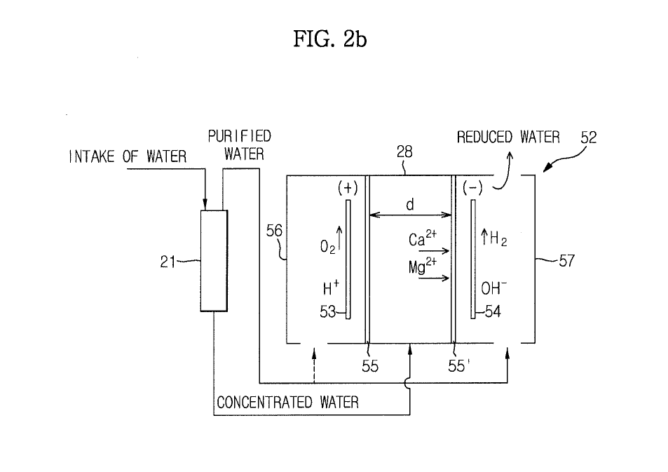

FIGS. 2A and 2B are schematic views illustrating the concept of operation of an apparatus for producing electrolytic reduced water according to an embodiment of the present disclosure.

The water purifying apparatus illustrated in FIGS. 2A and 2B includes a purifying apparatus 21 and an electrolytic cell 22.

The purifying apparatus 21 according to the embodiment of the present disclosure is an RO filter. However, the purifying apparatus according to the present disclosure is not limited thereto, and may include a distillatory apparatus or a capacitive deionization apparatus (CDI) that produces low-conductivity water having a difficulty in electrolysis. Hereinafter, the description will be made in relation that an RO filter is implemented as an example of the purifying apparatus.

The electrolytic cell 22 includes the first chamber 26 having the cathode 23, the second chamber 27 having the anode 24, and the third chamber 28 disposed between the first chamber 26 and the second chamber 27, in which the cathode 23 and the anode 24 are provided for electrolysis of water. Cation exchange membranes 25 and 25′ are provided between the first chamber 26 having the cathode 23 and the third chamber 28, and between the third chamber 28 and the second chamber 27 having the anode 24, respectively.

The electrolytic cell 22 is supplied with water passing through the RO filter 21 such that the first chamber 26 having the cathode 23 is supplied with purified water, which is deprived of minerals, ions, and organic substances from source water while passing through the RO filter 21, and the third chamber 28 is supplied with waste water other than the purified water, in which the waste water, concentrated with minerals, ions, and organic substances, is referred to as concentrated water.

Such concentrated water, having high concentration of mineral and ions, has a conductivity exceeding normal tap water. Accordingly, in a manner to supply the third chamber 28 with the concentrated water, the purified water, which is purified through reverse osmosis, may come into electrolysis and produce the reduced water. Such concentrated water is naturally generated in the purifying system using the RO filter 21, and the concentrated water is generated by three times more than the purified water is. In general, the concentrated water is drained without having a certain use.

According to the embodiment of the present disclosure, the concentrated water to be discarded is supplied to the third chamber 28, which corresponds to the middle chamber, so that electricity flows effectively between the cathode 23 and the anode 24 without an additional construction for flowing electricity, thereby enhancing the efficiency in electrolysis of pure water that is filtered through the osmosis.

The second chamber 27 having the anode 24 may be supplied with the purified water that is supplied to the first chamber 26. The supply of purified water to the second chamber 27 may be optional.

Since the cation exchange membrane 25′ comes into close contact with the anode 24, the anode 24 performs the electrolysis on the water that is permeated into the cation exchange membrane 25′ even if the purified water is not supplied to the second chamber 27. That is, even if the purified water is not introduced into the anode 24, the electrolysis is performed without a difficulty. Preventing the purified water from being introduced to the anode 24 is desired in terms of saving water.

A valve (not shown) may be installed on a line supplying the purified water or the concentrated water to each chamber so as to adjust the flow of water. By adjusting the valve, the amount of speed of the water introduced is controlled.

As shown in reaction 1, if a voltage of 2.057V or above is applied, H+ ions, which are generated through electrolysis between the anode 24 and the soaked cation exchange membrane 25′ adjacent to the anode, moves via the cation exchange membrane 25′ to the concentrated water that is supplied to the third chamber 28. Accordingly, the H+ ions, in cooperation with the calcium ions and magnesium ions that exist in the concentrated water, enables electric current to effectively flow between the cathode 23 and the anode 24, thereby enhancing the electrolysis.

The following table 1 shows the result of analysis of the reduced water that is generated according to the embodiment of the present invention while varying the experimental condition. Referring to table 1, it is proven that the water discharged from the first chamber 26 is the reduced water having a reducing power, and takes on a pH ranging from neutral to alkali.

TABLE 1

| | Experiment 1 | Experiment 2 | Experiment 3 |
|---|---|---|---|
| Thickness of | 10 | 10 | 8 |
| Chamber 3 (d) (mm) | | | |
| Flow Rate of | 100 | 80 | 100 |
| Chamber 1 (ml/min) | | | |
| Flow Rate of | 100 | 260 | 100 |
| Chamber 3 (ml/min) | | | |
| Application of | 30 V, 0.55 A | 30 V, 0.6 A | 24 V, 0.79 A |
| Electricity | | | |
| Outtake of Chamber | pH: 7.75 | pH: 10.5 | pH: 9.5 |
| 1 (reduced water) | ORP: −109 mV | ORP: −300 mV | ORP: −350 mV |

Source water (tap water) - pH: 7.47, conductivity: 252.9 uS/cm, temperature of water: 24.1° C.,
purifying apparatus - RO filter manufactured by TFC,
electrode - platinum electrode sized with 60 × 80 mm²
cation exchange membrane: cation exchange membrane manufactured by ASTOM

The concentrated water supplied to the third chamber 28 contains cations, at least small amount, such as calcium ions and magnesium ions. For a long period of use, the calcium ions or magnesium ions as such may be extracted from the cathode 23 and form scales on the cathode 23. In this regard, the polarities of the anode 24 and the cathode 23 of the electrolytic cell 22 of FIG. 2A may be alternately reversed between each other, and the water introduced to the electrolytic cell 22 may be alternately changed between the cathode and the anode, thereby preventing the scales from being formed. Periodic reversal of the electrode may remove the scales formed on the cathode or prevent scales from being formed.

According to the reversal of electrodes, the cathode 23 shown in FIG. 2A serves as an anode 53 in FIG. 2B, and the anode 24 shown in FIG. 2A serves as a cathode 54 in FIG. 2B. Therefore, the purified water passing through the RO filter in FIG. 2B is introduced into a first chamber 57 having the cathode 54. The electrolytic cell is laterally symmetric while having the third chamber 28 as a center, and the cathode 23 and the anode 24 are alternated depending on which electrode is applied.

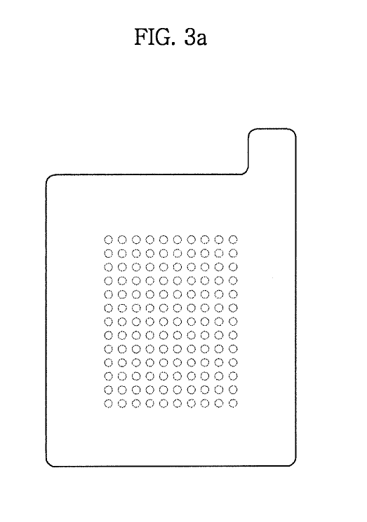

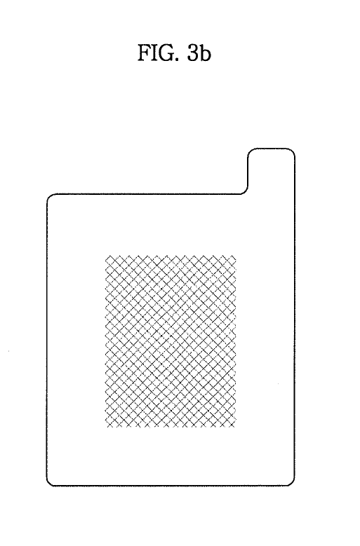

The cathode 23 and the anode 24 used in the electrolytic cell according to the present disclosure may include pores that are spaced apart from each other at equal intervals (see FIG. 3A) to allow water to pass therethrough, or may be provided in a mesh type structure with an increased surface area (see FIG. 3B).

Such a pore structure or a mesh type structure may enhance the efficiency of electrolysis. The electrode may be formed by coating a titanium electrode, which is stable in terms of somatology, with platinum, which is also stable in terms of somatology and has superior conductivity without causing ionization by the electric voltage.

According to an apparatus for producing electrolytic reduced water of an embodiment of the present disclosure, a cathode 83 may come into close contact with a cation exchange membrane 85, and an anode 8 may come into close contact with a cation exchange membrane 85′.

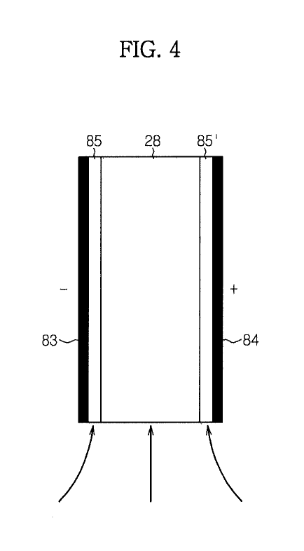

FIG. 4 is a view illustrating the configuration of the third chamber 28, the cation exchanger membranes, and the electrode in the apparatus for producing electrolytic reduced water according to the embodiment of the present disclosure.

If the cation exchange membranes 85 and 85′ are spaced apart from the electrodes 83 and 84 by a predetermined interval, the efficiency in the electrolysis of the anode 84 and the efficiency in transferring the cations may be degraded.

Accordingly, the cation exchange membranes 85 and 85′ are desired to come into close contact with the electrodes 83 and 84, respectively, as illustrated in FIG. 4.

The apparatus for producing electrolytic reduced water according to the present disclosure can produce pure and reduced water, which is deprived of organic compounds, pesticides, heavy metal, and inorganic ion components as well as free chlorine residual, chromaticity, chloroform, turbidity, chloroform, microorganism, and germs while a reducing power, thereby providing applications for the water purifier market and the alkaline ionizer market.

In addition, the apparatus for producing electrolytic reduced water according to the present disclosure can be applied to a dispenser of a refrigerator for houses and shops, or to an indoor humidifier. In addition, the water produced by the electrolytic reduced water producing apparatus according to the present disclosure has a maximum level of dissolved hydrogen at room temperature, and has a small cluster of water molecules that produce a highly activated reduced water suitable for health, beauty care, and crop cultivation

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. An apparatus for producing electrolytic reduced water, the apparatus comprising:
a water purifying apparatus; and
an electrolytic cell provided with a first chamber having a cathode, a second chamber having an anode, and a third chamber disposed between the first chamber and the second chamber to receive concentrated water from the water purifying apparatus.

2. The apparatus of claim 1, wherein the water purifying apparatus comprises a reverse osmosis filter, a distillatory apparatus, and a capacitive deionization apparatus.

3. The apparatus of claim 1, further comprising a valve configured to control a flow of purified water supplied from the water purifying apparatus such that the purifier water is supplied to the first chamber or the second chamber.

4. The apparatus of claim 1, wherein the electrolytic cell comprises a cation exchanger membrane that is formed between the first chamber and the third chamber and between the third chamber and the second chamber.

5. The apparatus of claim 4, wherein the cathode comes into close contact with the cation exchange membrane, and the anode comes into close contact with the cation exchange membrane.

6. The apparatus of claim 1, wherein each of the cathode and the anode is formed thereon with a pore that allows water to pass therethrough.

7. The apparatus of claim 1, wherein each of the cathode and the anode is provided in a mesh-type structure.

8. The apparatus of clam 1, wherein the water purifying apparatus supplies the first chamber or the second chamber with the purified water, and supplies the third chamber with concentrated water that remains after generating the purified water.

9. The apparatus of claim 1, wherein the cathode and the anode are reversed with each other to prevent scales from being formed on the cathode.
